(19) United States
(12) Patent Application Publication
(10) Pub. No.: US 2026/0029835 A1
(43) Pub. Date: Jan. 29, 2026

(54) TEMPERATURE-BASED DELAYING OF MEMORY POWER STATE TRANSITION

(71) Applicant: Micron Technology, Inc., Boise, ID (US)

(72) Inventor: Giuseppe Cariello, Boise, ID (US)

(21) Appl. No.: 19/277,609

(22) Filed: Jul. 23, 2025

Related U.S. Application Data
(60) Provisional application No. 63/676,789, filed on Jul. 29, 2024.

(51) Int. Cl. G06F 1/3234; G06F 1/3225

(52) U.S. Cl. CPC G06F 1/3275; G06F 1/3225

(57) ABSTRACT

Various embodiments described herein provide for delaying a power state transition of a memory system, such as a memory sub-system, based on a temperature associated with the memory system. In particular, various embodiments wait for a time delay value between a memory system entering an idle state and transitioning (e.g., from a normal or active power state) to a lower power state that is lower than a current power state of the memory system, where the time delay is dynamically determined based on a set of factors that includes a temperature associated with the memory system.

### PRIORITY APPLICATION

This application claims the benefit of priority to U.S. Provisional Application Ser. No. 63/676,789, filed Jul. 29, 2024, which is incorporated herein by reference in its entirety.

### TECHNICAL FIELD

Embodiments of the disclosure relate generally to memory systems and, more specifically, to delaying a power state transition of a memory system, such as a memory sub-system, based on a temperature associated with the memory system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is a block diagram illustrating an example computing system that includes a memory sub-system, in accordance with some embodiments of the present disclosure.

FIG. 2 is a flow diagram illustrating an example method for delaying a power state transition of a memory system based on a temperature associated with the memory system, in accordance with some embodiments of the present disclosure.

FIG. 3 is a block diagram of an example computer system in which embodiments of the present disclosure may operate.

### DETAILED DESCRIPTION

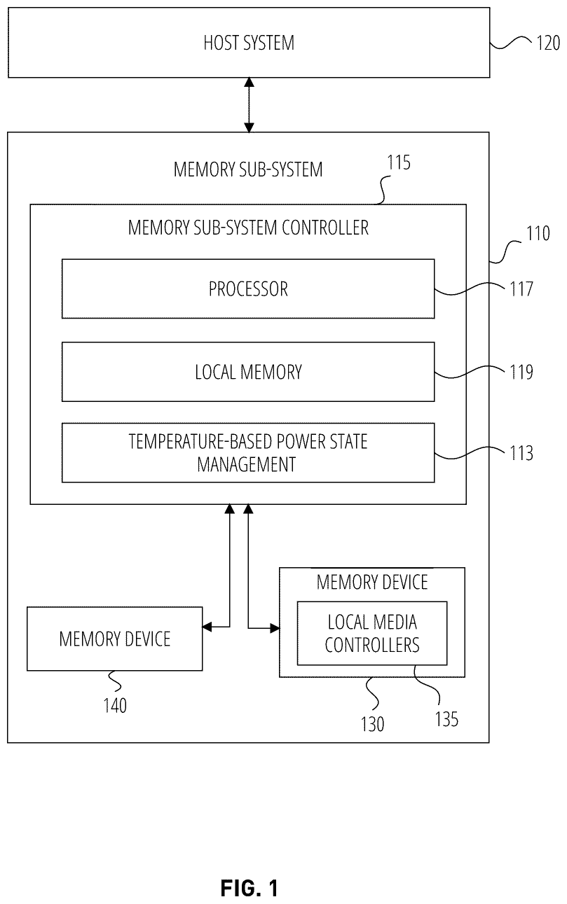

Aspects of the present disclosure are directed to delaying a power state transition of a memory system, such as a memory sub-system, based on a temperature associated with the memory system. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write command, read command) to the memory sub-system, such as to store data on a memory device at the memory sub-system, read data from the memory device on the memory sub-system, or write/read constructs (e.g., such as submission and completion queues) with respect to a memory device on the memory sub-system. The data to be read or written, as specified by a host request, is hereinafter referred to as “host data” or “user data.”

A host request can include logical address information (e.g., logical block address (LBA), namespace) for the host data, which is the location the host system associates with the host data and a particular zone in which to store or access the host data. The logical address information (e.g., LBA, namespace) can be part of metadata for the host data. Metadata can also include error handling data (e.g., error-correcting code (ECC) code word, parity code), data version (e.g., used to distinguish age of data written), valid bitmap (which LBAs or logical transfer units contain valid data), and so forth.

The memory sub-system can initiate media management operations, such as a write operation, on host data that is stored on a memory device. For example, firmware of the memory sub-system may re-write previously written host data from a location of a memory device to a new location as part of a garbage collection management operation (or garbage collection process). The data that is re-written, for example as initiated by the firmware, is hereinafter referred to as “garbage collection data.”

“User data” hereinafter generally refers to host data and garbage collection data. “System data” hereinafter refers to data that is created and/or maintained by the memory sub-system for performing operations in response to host requests and for media management. Examples of system data include, and are not limited to, system tables (e.g., logical-to-physical memory address mapping table (also referred to herein as a L2P table), data from logging, scratch pad data, and so forth).

A memory device can be a non-volatile memory device. A non-volatile memory device is a package of one or more die. Each die can be comprised of one or more planes. For some types of non-volatile memory devices (e.g., AND-type devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are a raw memory device combined with a local embedded controller for memory management within the same memory device package. The memory device can be divided into one or more zones where each zone is associated with a different set of host data or user data or application.

Certain memory devices, such as NAND-type memory devices, comprise one or more blocks, (e.g., multiple blocks), with each of those blocks comprising multiple memory cells. For instance, a memory device can comprise multiple pages (also referred to as wordlines), with each page comprising a subset of memory cells of the memory device. A threshold voltage (VT) of a memory cell (of a block) can be the voltage at which the floating gate (e.g., NAND transistor), implementing the memory cell, turns on and conducts (e.g., to a bit line coupled to the memory cell). Generally, writing data to such memory devices involves programming (by way of a program operation) the memory devices at the page level of a block, and erasing data from such memory devices involves erasing the memory devices at the block level (e.g., page level erasure of data is not possible).

In the realm of mobile devices (such as smartphones), two factors that influence customer satisfaction are power efficiency and system responsiveness. These two factors, however, inherently conflict with each other. On one hand, there is a desire to minimize power consumption to extend the battery life of a mobile device, and on the other, there is a desire to ensure that devices respond quickly to user commands, thereby enhancing the quality of service (QoS). Enhancing power efficiency (by minimizing power consumption) typically involves reducing the operational readiness of components of a mobile device, such as memory-related components, which can extend the time it takes for the mobile device to respond to new commands. At the same time, improving system responsiveness generally involves components (such as memory-related components) remaining in a ready state, which increases power consumption in the mobile device.

A particular challenge arises in managing the transition of a memory sub-system (e.g., solid-state drive (SSD) of a mobile device) between active and idle states. During periods of inactivity, a memory sub-system can enter (e.g., transition to) a lower power state (e.g., a low power state), which can involve shutting down unnecessary components of the memory device, such as a memory sub-system controller's local memory (e.g., Static Random-Access Memory (SRAM)) or other unused integrated processes (IPs) of a memory sub-system. This lower power state can be useful for conserving energy (e.g., extending the battery life of a mobile device), especially when the memory sub-system and a host system operably coupled to the memory sub-system are idle (e.g., the data link between the memory sub-system and host system is in a physical layer (PHY) state of hibernation), with no background operations (hereafter, also referred to as BKOPS) like garbage collection or refresh operations are to be performed.

However, the process of a memory sub-system entering into and exiting from a lower power state can affect the memory sub-system's responsiveness. For example, when a memory sub-system enters a lower-power state, a time delay induced by flushing information (e.g., one or more tables and firmware of the memory sub-system controller) stored on local memory (e.g., SRAM) of a memory sub-system controller (e.g., flush to a non-volatile memory device, such as a NAND-type memory device of the memory sub-system) and to shut down the local memory can significantly impact the latency of the memory sub-system processing new commands from the host system. This latency can be a direct consequence of the time spent by the memory sub-system to exit the lower power state and enter a higher power state to resume a higher (e.g., full) operation, which can involve reloading flushed information (e.g., one or more tables) from a non-volatile memory device to the local memory or loading firmware of the memory sub-system controller.

An additional challenge in power management is the phenomenon of leakage in the circuitry of various components within electronic devices (e.g., mobile devices), such as the circuitry of a memory sub-system (e.g., circuitry of memory device die). As used herein, leakage can refer to the unwanted flow of electrical current within a circuit when the circuit is in an idle state, which can lead to increased power consumption even when the circuit is not performing any active functions. As electronic devices such as mobile devices have transitioned to components (e.g., memory device die) with smaller technology (e.g., transitioned from 15 nm transistors to 7 nm transistors), leakage currents within the electronic devices have increased. Management of leakage within electronic devices is usually further complicated by temperature variations. In particular, leakage of a circuit (e.g., transistors of an integrated circuit (IC)) can be dependent on the temperature of the circuit; usually, leakage within a circuit increases with the temperature of the circuit.

Traditionally, the approach to managing the transition of memory sub-systems into lower power states (e.g., a low power state that causes various components of the memory sub-system to be powered down) has involved fixed delays. Unfortunately, using fixed delays does not take into consideration dynamic conditions (e.g., environmental conditions) associated with memory sub-systems, such as temperature changes, which can significantly affect the power profile of the memory sub-systems.

Various embodiments described herein provide for delaying a power state transition of a memory system, such as a memory sub-system, based on a temperature associated with the memory system. In particular, various embodiments wait for a time delay value between a memory system entering an idle state and transitioning (e.g., from a normal or active power state) to a lower power state that is lower than a current power state of the memory system, where the time delay is dynamically determined based on a set of factors that includes a temperature associated with the memory system. For example, the lower power state comprises a low power state that causes various components of the memory sub-system to be powered down. Depending on the embodiment, the lower power state (e.g., low or lowest power state) is defined by a power management protocol associated with the memory system. A memory system can enter an idle state, for example, when it has no commands from a host system to process and no background operations (e.g., BKOPs) to perform. The temperature can be provided by a thermal sensor (e.g., temperature sensor), which can measure the temperature (e.g., ambient temperature) of an environment external to the memory system (e.g., a thermal sensor disposed on an outer housing or case of the memory system), the temperature of an environment internal to the memory system, or the temperature of a component of the memory system (e.g., a memory device of the memory sub-system).

For some embodiments, the higher the value of the temperature, the lower the time delay value determined. Generally, the higher the temperature of circuity of a memory system (e.g., memory device die), the higher the leakage present in the circuitry. In view of this, various embodiments attempt to reduce the time delay between a memory system entering the idle state and transitioning to a lower power state during higher temperatures in order to reduce the amount of time of increased leakage within the memory system due to high temperature. In doing so, some embodiments can increase power savings by the memory system and can increase the battery life of a mobile device that includes the memory system. At the same time, various embodiments attempt to maintain the responsiveness of a memory system by determining a longer time delay (between an idle state and a lower power state transition) when the temperature associated with the memory system is lower, thereby delaying the memory system entering a lower power state that takes time to exit when responding to a new command from a host system. Overall, by dynamically determining (e.g., adjusting) the time delay based on temperature (and possibly other factors), various embodiments can balance conserving energy (e.g., by reducing the time delay during higher temperatures to reduce leakage within a memory system) with maintaining responsiveness of the memory system (e.g., by increasing the time delay during lower temperatures to reduce the number of instances where the memory system has to exit a lower power state to respond to a new host command received during the lower power state).

As used herein, a thermal sensor can comprise a temperature sensor. Additionally, a temperature can refer to a temperature measured by a sensor that can sense or measure temperature, such as a thermal sensor (e.g., temperature sensor). For example, a temperature associated with a memory device can be the temperature of a physical surface (e.g., of an outer housing or case) of a memory device of a memory sub-system (e.g., as measured by a thermal sensor disposed on the surface) or the temperature of an environment in which the memory device is operating (e.g., as measured by a thermal sensor deployed within the environment).

Disclosed herein are some examples of delaying a power state transition of a memory system (e.g., memory sub-system) based on a temperature associated with the memory system, as described herein.

FIG. 1 illustrates an example computing system 100 that includes a memory sub-system 110, in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a NAND type flash memory and write-in-place memory, such as a three-dimensional (3D) cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130, 140 can include one or more arrays of memory cells. One type of memory cell, for example, single-level cells (SLCs), can store one bit per cell. Other types of memory cells, such as multiple-layer cells (MLCs), triple-layer cells (TLCs), quad-level cells (QLCs), and penta-level cells (PLCs), can store multiple bits per cell. In some embodiments, each of the memory devices 130, 140 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130, 140 can be grouped as pages that can refer to a logical unit of the memory device used to store data. With some types of memory (e.g., NAND), pages can be grouped to form blocks. As used herein, a block comprising SLCs can be referred to as a SLC block, a block comprising MLCs can be referred to as a MLC block, a block comprising TLCs can be referred to as a TLC block, and a block comprising QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130, 140 to perform operations such as reading data, writing data, or erasing data at the memory devices 130, 140 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, garbage collection operations, error detection and ECC operations, encryption operations, caching operations, and address translations between a logical address (e.g., LB A, namespace) and a physical memory address (e.g., physical block address) that are associated with the memory devices 130, 140. The memory sub-system controller 115 can further include host interface circuitry to communicate with the host system 120 via the physical host interface. The host interface circuitry can convert the commands received from the host system 120 into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130, 140.

In some embodiments, the memory device 130 includes local media controllers 135 that operate in conjunction with memory sub-system controller 115 to execute operations on one or more memory cells of the memory device 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local media controller 135) for media management within the same memory device package. An example of a managed memory device is a managed NAND (MNAND) device.

The memory sub-system controller 115 includes a temperature-based power state management 113 that enables or facilitates the memory sub-system controller 115 to delay a power state transition of the memory sub-system 110 based on a temperature associated with the memory sub-system 110 in accordance with various embodiments described herein. Alternatively, some or all of the temperature-based power state management 113 is included by the local media controller 135, thereby enabling the local media controller 135 to enable or facilitate delaying of a power state transition of the memory sub-system 110 based on a temperature associated with the memory sub-system 110.

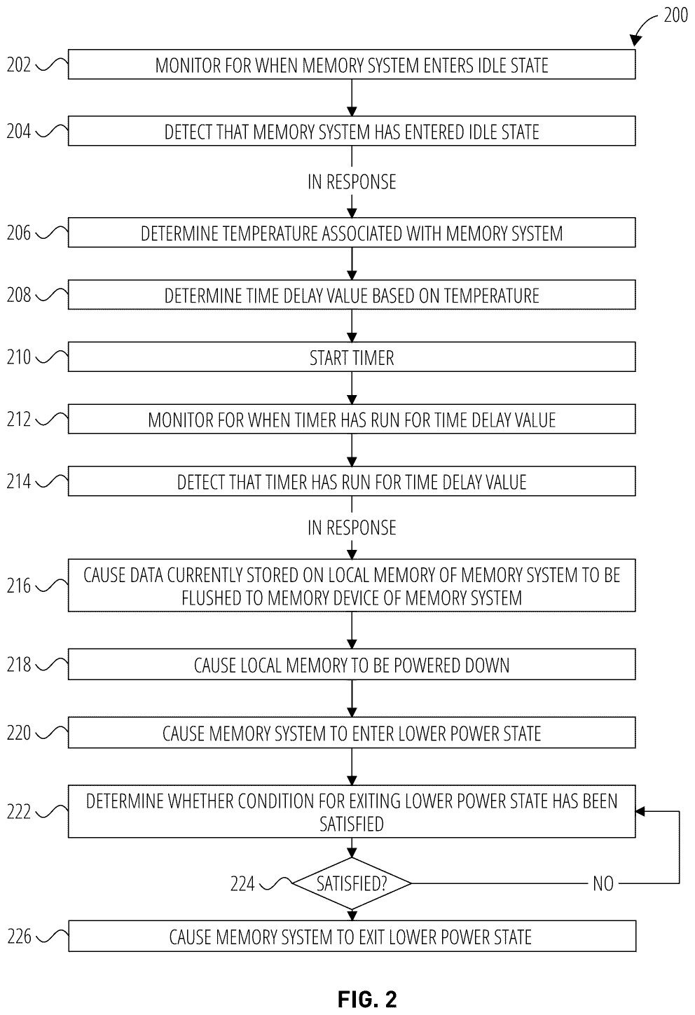

FIG. 2 is a flow diagram illustrating an example method 200 for delaying a power state transition of a memory system (e.g., a memory sub-system) based on a temperature associated with the memory system, in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the memory sub-system controller 115 of FIG. 1 based on the temperature-based power state management 113. Additionally, or alternatively, for some embodiments, the method 200 is performed, at least in part, by the local media controller 135 of the memory device 130 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are used in every embodiment. Other process flows are possible.

Referring now to the method 200 of FIG. 2, at operation 202 a processing device (e.g., the processor 117 of the memory sub-system controller 115) monitors for when a memory system (e.g., memory sub-system 110) enters an idle state. The idle state monitoring can be performed periodically or in response to a trigger condition. Depending on the embodiment, a memory system can enter (and thereafter be in) an idle state (e.g., from an active or operational state) when the memory system is not processing any commands received from a host system (e.g., host system 120) operably coupled to the memory system, when the memory system is not performing any internal operations (e.g., background operations, such as garbage collection or refresh operations), or a combination of both. For example, a memory system can enter an idle state when a data link between the memory system and a host system (e.g., host system 120) is idle or set to hibernation. When a memory system is processing a new command received from a host system (e.g., host system 120) or performing a background operation, such as garbage collection, the memory system can be considered to be in a non-idle state, such as an active state.

At operation 204, the processing device (e.g., the processor 117 of the memory sub-system controller 115) detects that the memory system (e.g., memory sub-system 110) has entered the idle state and, in response, the method 200 proceeds to operation 206. During operation 206, the processing device determines a temperature associated with the memory system. For some embodiments, operation 206 comprises obtaining the temperature from a thermal sensor (e.g., temperature sensor) associated with the memory system, where the thermal sensor may or may not be part of the memory system. The thermal sensor can measure the temperature (e.g., ambient temperature) of an environment external to the memory system (e.g., a thermal sensor disposed on an outer housing or case of the memory system), the temperature of an environment internal to the memory system, or the temperature of a component of the memory system (e.g., a memory device of the memory sub-system). Alternatively, the temperature can be provided by a host system (e.g., 120) operably coupled to the memory system, where the host system can provide a measured temperature of the host system, such as the measured temperature of an internal environment of the host system that contains the memory system, or the measured temperature of an external environment of the host system.

For operation 208, the processing device (e.g., the processor 117 of the memory sub-system controller 115) determines a time delay value (e.g., in milliseconds) based on the temperature associated with the memory system (e.g., memory sub-system 110). For some embodiments, operation 208 comprises determining the time delay value based on a predetermined function and the temperature. For example, the predetermined function can receive a value of the temperature as an input, and generate as output a time delay value (e.g., in milliseconds). For instance, the predetermined function can output a time delay value of 10 ms for an input temperature value that indicates room temperature, and can indicate a time delay value of 1 ms for an input temperature value of 85 Fahrenheit. Depending on the embodiment, the predetermined function can comprise a linear function or a logarithmic function. For some embodiments, operation 208 comprises determining the time delay value based on the temperature and a usage pattern of the memory system. For example, a predetermined function used by an embodiment can consider an input temperature value and the usage pattern (e.g., historical usage pattern) of the memory system. Some embodiments use a usage pattern of the memory system to determine a statistical value (e.g., probability) that the memory system will be used again after the memory system has been in an idle state for a given amount of time (e.g., 1 ms). For some embodiments, operation 208 comprises determining the time delay value based on the temperature and a definable parameter. For example, the definable parameter can be a parameter set by a manufacturer of the memory system, or set by a user of the memory system. The definable parameter, which can be a numerical value, can determine how tight or relaxed the processing device will be when determining the time delay value (e.g., based on the temperature). The definable parameter can function as a quality-of-service (QoS) parameter of the memory system, which can define how important the QoS of the memory system (e.g., the responsiveness of the memory system to commands from the host system) is compared to reducing power consumption on the memory system. Depending on the embodiment, the definable parameter can be set by a command (e.g., vendor-specific command) received by the memory system (e.g., memory sub-system 110) from a host system (e.g., 120) operable coupled to the memory system. For some embodiments, operation 208 comprises determining the time delay value based on the temperature a prediction mechanism that is configured to predict when the memory system will exit from the idle state (after entering the idle state). For some embodiments, the processing device determines the time delay value based on the temperature and a combination of other factors, where the other factors can include one or more of a predetermined function, a usage pattern of the memory system, a definable parameter, a prediction mechanism, and the like.

Thereafter, at operation 210, the processing device (e.g., the processor 117 of the memory sub-system controller 115) starts a timer to determine when the time delay value has elapsed. After the timer has started, during operation 212, the processing device monitors for when the timer has run for the time delay value. For some embodiments, the timer is part of the memory system (e.g., memory sub-system 110), such as a hardware-based timer of the memory system. At operation 214, the processing device (e.g., the processor 117 of the memory sub-system controller 115) detects that the timer has run for the time delay value and, in response, the method 200 proceeds to operation 216. For some embodiments, the timer comprises a countdown timer, where the countdown timer can be set to the time delay value prior to being started (by operation 210), and where the timer is detected to have run for the time delay value when the counter timer expires.

Operations 216 and 218 can be performed prior to the processing device (e.g., the processor 117 of the memory sub-system controller 115) causing the memory system (e.g., memory sub-system 110) to enter (e.g., transition to) a lower power state at operation 220. At operation 216, the processing device causes data currently stored on a local memory (e.g., local memory 119 of the memory sub-system controller 115) to be flushed to a memory device (e.g., 130) of the memory system (e.g., memory sub-system 110). Additionally, at operation 218, the processing device causes the local memory (e.g., 119) to power down. Eventually, at operation 220, the processing device causes the memory system to enter (e.g., from a current higher power state, such as a full power state) to the lower power state, such as a low power state (e.g., that causes various components of the memory sub-system to be powered down).

After operation 220, at operation 222, the processing device (e.g., the processor 117 of the memory sub-system controller 115) determines whether a condition for the memory system to exit the lower power state has been satisfied. For instance, the condition can include that the memory system receives a new command to process from a host system (e.g., 120) while the memory system is in the lower power state. As another example, the condition can include the memory system exiting the lower power state based on the memory system detecting an error or fault in the memory system while the memory system is in the lower power state. At decision block 224, in response to the processing device (e.g., the processor 117 of the memory sub-system controller 115) determining that the condition is satisfied, the method 200 proceeds to operation 226, where the processing device causes the memory system to exit the lower power state (e.g., and enter a higher power state, such as a full power state), which can enable the memory system to respond to commands from the host system. Alternatively, at decision block 224, in response to the processing device determining that the condition is not satisfied, the method 200 returns to the operation 222, where the processing device can redetermine whether a condition for the memory system to exit the lower power state has been satisfied.

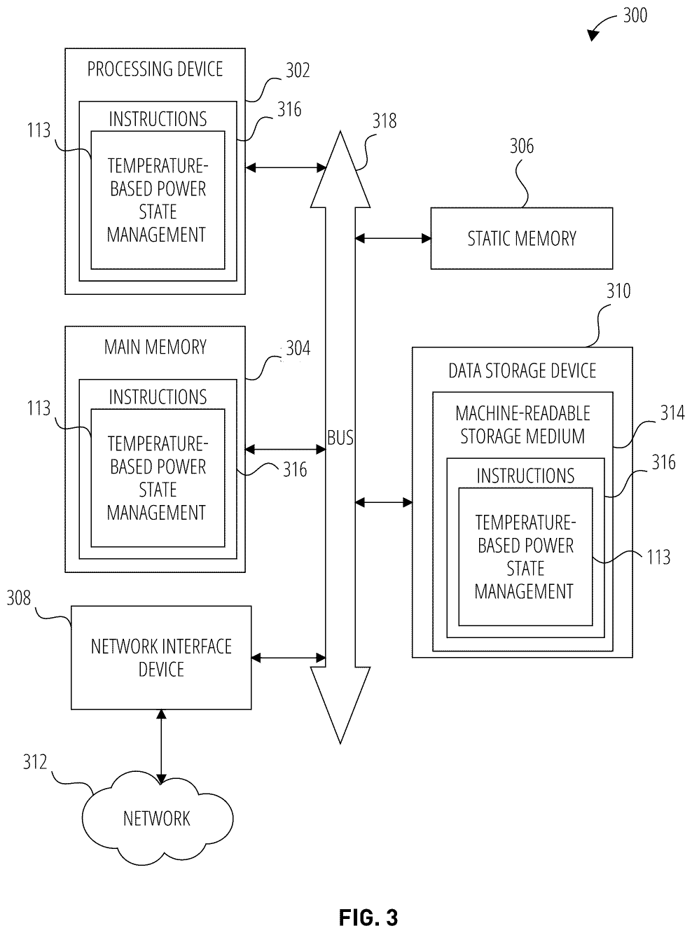

FIG. 3 illustrates an example machine in the form of a computer system 300 within which a set of instructions can be executed for causing the machine to perform any one or more of the methodologies discussed herein. In some embodiments, the computer system 300 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 300 includes a processing device 302, a main memory 304 (e.g., ROM, flash memory, DRAM such as SDRAM or Rambus DRAM (RDRAM), etc.), a static memory 306 (e.g., flash memory, static random access memory (SRAM), etc.), and a data storage device 310, which communicate with each other via a bus 318.

The processing device 302 represents one or more general-purpose processing devices such as a microprocessor, a central processing unit, or the like. More particularly, the processing device 302 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 302 can also be one or more special-purpose processing devices such as an application-specific integrated circuit (ASIC), a field programmable gate array (FPGA), a digital signal processor (DSP), a network processor, or the like. The processing device 302 is configured to execute instructions 316 for performing the operations and steps discussed herein. The computer system 300 can further include a network interface device 308 to communicate over a network 312.

The data storage device 310 can include a machine-readable storage medium 314 (also known as a computer-readable medium) on which is stored one or more sets of instructions 316 or software embodying any one or more of the methodologies or functions described herein. The instructions 316 can also reside, completely or at least partially, within the main memory 304 and/or within the processing device 302 during execution thereof by the computer system 300, the main memory 304 and the processing device 302 also constituting machine-readable storage media. The machine-readable storage medium 314, data storage device 310, and/or main memory 304 can correspond to the memory sub-system 110 of FIG. 1.

In one embodiment, the instructions 316 include instructions to implement functionality corresponding to delay a power state transition of the memory sub-system based on a temperature associated with the memory sub-system as described herein (e.g., the temperature-based power state management 113 of FIG. 1). While the machine-readable storage medium 314 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Described implementations of the subject matter can include one or more features, alone or in combination as illustrated below by way of examples.

Example 1 is a memory system comprising: a memory device; and a processing device, operatively coupled to the memory device, configured to perform operations comprising: detecting that the memory system has entered an idle state; and in response to detecting that the memory system has entered the idle state and prior to transitioning the memory system from a current power state to a lower power state: determining a time delay value based on a temperature associated with the memory system; starting a timer for the time delay value; and in response to detecting that the timer has run for the time delay value, causing the memory system to enter the lower power state.

In Example 2, the subject matter of Example 1 includes, wherein the determining of the time delay value of the timer based on the temperature associated with the memory system comprises: determining the time delay value based on a predetermined function and the temperature.

In Example 3, the subject matter of Example 2 includes, wherein the predetermined function comprises a linear function.

In Example 4, the subject matter of Examples 2-3 includes, wherein the predetermined function comprises a logarithmic function.

In Example 5, the subject matter of Examples 1-4 includes, wherein the determining of the time delay value of the timer based on the temperature associated with the memory system comprises: determining the time delay value based on the temperature and a usage pattern of the memory system.

In Example 6, the subject matter of Examples 1-5 includes, wherein the determining of the time delay value of the timer based on the temperature associated with the memory system comprises: determining the time delay value based on the temperature and a definable parameter.

In Example 7, the subject matter of Example 6 includes, wherein the memory system is a memory sub-system, and wherein the definable parameter is set by a vendor-specific command received by the memory sub-system from a host system operable coupled to the memory sub-system.

In Example 8, the subject matter of Examples 1-7 includes, wherein the operations comprise: in response to detecting that the memory system has entered the idle state, determining the temperature prior to the determining of the time delay value of the timer.

In Example 9, the subject matter of Examples 1-8 includes, wherein the temperature comprises a temperature of an environment external to the memory system.

In Example 10, the subject matter of Examples 1-9 includes, wherein the temperature comprises a temperature of an environment internal to the memory system.

In Example 11, the subject matter of Examples 1-10 includes, wherein the temperature comprises a temperature of the memory device.

In Example 12, the subject matter of Examples 1 -11 includes, a thermal sensor configured to measure the temperature.

In Example 13, the subject matter of Examples 1-12 includes, a local memory operatively coupled to the processing device, the operations comprising: prior to the causing of the memory system to enter the lower power state: causing data currently stored on the local memory to be flushed to the memory device; and causing the local memory to be powered down.

In Example 14, the subject matter of Examples 1-13 includes, wherein the memory system enters idle state when the memory system has no commands from a host system to process.

In Example 15, the subject matter of Examples 1-14 includes, wherein the lower power state is defined in a power management protocol associated with the memory system.

In Example 16, the subject matter of Examples 1-15 includes, wherein the timer comprises a countdown timer, and wherein the timer is detected to have run for the time delay value when the timer expires.

In Example 17, the subject matter of Examples 1-16 includes, wherein the operations comprise: after the causing of the memory system to enter the lower power state: determining whether a condition for the memory system to exit the lower power state has been satisfied; and causing the memory system to exit the lower power state in response to determining that the condition is satisfied.

Example 18 is a method to implement any of Examples 1-17.

Example 19 is at least one machine-readable medium comprising instructions that, when executed by a processing device, cause the processing device to perform operations to implement any of Examples 1-17.

Example 20 is at least one machine-readable storage medium comprising instructions that, when executed by a processing device of a memory sub-system, cause the processing device to perform operations comprising: detecting that the memory sub-system has entered an idle state; and in response to detecting that the memory sub-system has entered the idle state and prior to transitioning the memory sub-system from a current power state to a lower power state: determining a time delay value based on a temperature associated with the memory sub-system; monitoring for when a timer has run for the time delay value; detecting that the timer has run for the time delay value; and in response to detecting that the timer has run for the time delay value, causing the memory sub-system to enter the lower power state.

In Example 21, the subject matter of Example 20 includes, wherein the determining of the time delay value of the timer based on the temperature associated with the memory sub-system comprises: determining the time delay value based on a predetermined function and the temperature.

Example 22 is a method to implement any of Examples 20-21.

Example 23 is a memory system to implement any of Examples 20-21.

Example 24 is a method comprising: detecting, by a processing device of a memory sub-system, that the memory sub-system has entered an idle state; and in response to detecting that the memory sub-system has entered the idle state and prior to transitioning the memory sub-system from a current power state to a lower power state: determining, by the processing device, a time delay value based on a temperature associated with the memory sub-system; detecting, by the processing device, that a timer has run for the time delay value; and in response to detecting that the timer has run for the time delay value, causing, by the processing device, the memory sub-system to enter the lower power state.

Example 25 is a memory system to implement Example 24.

Example 26 is at least one machine-readable medium comprising instructions that, when executed by a processing device, cause the processing device to perform operations to implement Example 24.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (such as a non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, and so forth. A machine-readable storage medium can be non-transitory (in other words, not having any transitory signals) in that it does not embody a propagating signal. However, labeling a machine-readable storage medium “non-transitory” should not be construed to mean that the machine-readable storage medium is incapable of movement; the machine-readable storage medium should be considered as being transportable from one physical location to another.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A memory system comprising:
a memory device; and
a processing device, operatively coupled to the memory device, configured to perform operations comprising:
detecting that the memory system has entered an idle state; and
in response to detecting that the memory system has entered the idle state and prior to transitioning the memory system from a current power state to a lower power state:
determining a time delay value based on a temperature associated with the memory system;
starting a timer for the time delay value; and
in response to detecting that the timer has run for the time delay value, causing the memory system to enter the lower power state.

2. The memory system of claim 1, wherein the determining of the time delay value of the timer based on the temperature associated with the memory system comprises:
determining the time delay value based on a predetermined function and the temperature.

3. The memory system of claim 2, wherein the predetermined function comprises a linear function.

4. The memory system of claim 2, wherein the predetermined function comprises a logarithmic function.

5. The memory system of claim 1, wherein the determining of the time delay value of the timer based on the temperature associated with the memory system comprises:
determining the time delay value based on the temperature and a usage pattern of the memory system.

6. The memory system of claim 1, wherein the determining of the time delay value of the timer based on the temperature associated with the memory system comprises:
determining the time delay value based on the temperature and a definable parameter.

7. The memory system of claim 6, wherein the memory system is a memory sub-system, and wherein the definable parameter is set by a vendor-specific command received by the memory sub-system from a host system operable coupled to the memory sub-system.

8. The memory system of claim 1, wherein the operations comprise:
in response to detecting that the memory system has entered the idle state, determining the temperature prior to the determining of the time delay value of the timer.

9. The memory system of claim 1, wherein the temperature comprises a temperature of an environment external to the memory system.

10. The memory system of claim 1, wherein the temperature comprises a temperature of an environment internal to the memory system.

11. The memory system of claim 1, wherein the temperature comprises a temperature of the memory device.

12. The memory system of claim 1, comprising a thermal sensor configured to measure the temperature.

13. The memory system of claim 1, comprising a local memory operatively coupled to the processing device, the operations comprising:
prior to the causing of the memory system to enter the lower power state:
causing data currently stored on the local memory to be flushed to the memory device; and
causing the local memory to be powered down.

14. The memory system of claim 1, wherein the memory system enters idle state when the memory system has no commands from a host system to process.

15. The memory system of claim 1, wherein the lower power state is defined in a power management protocol associated with the memory system.

16. The memory system of claim 1, wherein the timer comprises a countdown timer, and wherein the timer is detected to have run for the time delay value when the timer expires.

17. The memory system of claim 1, wherein the operations comprise:
after the causing of the memory system to enter the lower power state:
determining whether a condition for the memory system to exit the lower power state has been satisfied; and
causing the memory system to exit the lower power state in response to determining that the condition is satisfied.

18. At least one non-transitory machine-readable storage medium comprising instructions that, when executed by a processing device of a memory sub-system, cause the processing device to perform operations comprising:
detecting that the memory sub-system has entered an idle state; and
in response to detecting that the memory sub-system has entered the idle state and prior to transitioning the memory sub-system from a current power state to a lower power state:
determining a time delay value based on a temperature associated with the memory sub-system;
monitoring for when a timer has run for the time delay value;
detecting that the timer has run for the time delay value; and
in response to detecting that the timer has run for the time delay value, causing the memory sub-system to enter the lower power state.

19. The non-transitory machine-readable storage medium of claim 18, wherein the determining of the time delay value of the timer based on the temperature associated with the memory sub-system comprises:
determining the time delay value based on a predetermined function and the temperature.

20. A method comprising:
detecting, by a processing device of a memory sub-system, that the memory sub-system has entered an idle state; and
in response to detecting that the memory sub-system has entered the idle state and prior to transitioning the memory sub-system from a current power state to a lower power state:
determining, by the processing device, a time delay value based on a temperature associated with the memory sub-system;
detecting, by the processing device, that a timer has run for the time delay value;
in response to detecting that the timer has run for the time delay value, causing, by the processing device, the memory sub-system to enter the lower power state.
